(19) United States
(12) Patent Application Publication
(10) Pub. No.: US 2008/0090625 A1
(43) Pub. Date: Apr. 17, 2008

(54) Microphone Microchip Device with Internal Noise Suppression

(75) Inventors: Olafur Josefsson, North Reading, MA (US); Anthony Volpe, North Andover, MA (US)

Correspondence Address: BROMBERG & SUNSTEIN LLP, 125 SUMMER STREET, BOSTON, MA, 02110-1618, US

(73) Assignee: ANALOG DEVICES, INC., Norwood, MA (US)

(21) Appl. No.: 11/870,434

(22) Filed: Oct. 11, 2007

Related U.S. Application Data
(60) Provisional application No. 60/829,000, filed on Oct. 11, 2006.

(51) Int. Cl. H04M 1/02

(52) U.S. Cl. 455/575.1

(57) ABSTRACT

A microphone microchip for a voice communication device. The microchip receives and processes an audio signal from a microphone. The microchip incorporates an RF filter that substantially attenuates noise signals at RF frequencies, while passing audio signals, substantially unattenuated. The filter is inserted between ports through which RF carrier signal noise can enter the microchip and internal elements of the microchip that provide a nonlinear response. Thus, modulated RF carrier noise is attenuated before this noise can interact with the nonlinear elements to convert the modulated carrier noise to audible interference. Corruption of microphone signals is thereby avoided.

This application claims priority from U.S. provisional patent application, Ser. No. 60/829,000, filed Oct. 11, 2006, entitled “Microphone Microchip with Internal Noise Suppression,” attorney docket no. 2550/B32, which is incorporated herein by reference.

### TECHNICAL FIELD

The invention generally relates to microphones for voice communication devices and, more particularly, the invention relates to noise suppression in microphone circuitry microchips for cellular telephones.

### BACKGROUND OF THE INVENTION

Cellular telephones typically have a microphone and associated circuitry to convert sound waves into an electronic signal for transmission to another telephone. The circuitry modulates a high frequency radio-frequency (“RF”) carrier signal (e.g., 1 to 2 GHz) with the microphone signal and transmits this modulated carrier signal via an antenna on the telephone. This modulated RF carrier signal is received by a base station (“a cell”) and forwarded to another telephone.

A block diagram for a conventional cellular telephone 10 is shown in FIG. 1. The telephone 10 has a body 12 with a microphone 14 for receiving sound input from a human voice, a loudspeaker 16 for generating sound output and an antenna 18 for transmitting and receiving modulated RF signals. The telephone includes receiver circuits for converting received RF signals to audio signals to drive the loudspeaker 16. Illustratively, the receiver electronics may include demodulating 20, signal processing 22, de-interleaving 24, speech decoding 26 and digital-to-analog conversion 28 components. The telephone 10 further includes transmitter circuits for converting sound input received by the microphone 14 to RF signals for transmission. Illustratively, the transmitter electronics may include buffering 38 analog-to-digital conversion 36, signal processing 34, interleaving 32, and modulating 30 components.

A cellular telephone typically comprises many physical components packed into a small physical space. Consequently, electromagnetic energy may escape from some of these components and couple into other cellular telephone components, thereby causing noise interference. (Of particular concern is the energy emitted from the telephone's antenna 18.) Pickup of noise signals at audio frequencies is particularly troublesome because these noise signals can interfere with the operation of the loudspeaker 16 or microphone 14. This audio interference can adversely affect the operation of the cellular telephone. A particular problem is the audio interference signal that may be induced by time division interleaving of transmitter signals with receiver signals in the telephone. Such interleaving can be performed by the receiver de-interleave circuit 24 and in the transmitter interleave circuit 32. For example, transmitter and receiver RF carrier signal interleaving is performed at a 217 Hz rate in a Time Division Multiple Access (“TDMA”) transmitter/receiver of a Global System for Mobile Communications (“GSM”) mobile telephone. Non-linear circuit elements in a cellular telephone can convert the turn-on and turn-off of the telephone's RF carrier for transmission at the 217 Hz rate into an audio interference signal at 217 Hz. Audio signal noise at this frequency resembles the sound of a bumblebee and is thus known as “bumblebee noise.” Such bumblebee noise can impact the ability of a cellular telephone to function as a voice communication device.

### SUMMARY OF THE INVENTION

In accordance with embodiments of the invention, a microchip processes a microphone signal in a voice communication device, such as a cellular telephone. The voice communication device employs a modulated RF carrier for signal transmission and reception. RF carrier signal noise may be coupled into the microchip via one or more noise signal ports, such as a microphone signal output port or a supply voltage port. RF carrier noise signals received via these ports are filtered internal to the microchip. The filter is implemented so that RF frequencies are substantially attenuated while signals at audio frequencies, typical of human voice, are substantially unaffected. One or more filters are inserted between ports where RF carrier signal noise is received and non-linear circuit elements in the microchip that process the microphone signals. Thus, conversion of audio frequency modulated RF carrier signals into audible interference by the non-linear elements, which can interfere with the microphone signal, is averted.

In embodiments of the invention, the filter may be a notch filter with the frequency suppression notch centered at RF carrier frequencies typical of the RF carrier frequencies used by the voice communication device.

### BRIEF DESCRIPTION OF THE DRAWINGS

The foregoing features of the invention will be more readily understood by reference to the following detailed description taken with the accompanying drawings:

FIG. 1 is a block diagram of a conventional cellular telephone;

FIG. 2 schematically shows a packaged microphone and processing microchip that may be used in the telephone of FIG. 1, in embodiments of the present invention;

FIG. 3 schematically shows a cross-sectional view of the microphone and processing microchip shown in FIG. 2; and

FIG. 4 is a circuit diagram of the microphone and processing microchip shown in FIGS. 2 and 3.

### DETAILED DESCRIPTION OF EMBODIMENTS OF THE INVENTION

As used herein, a “nonlinear circuit element” will mean any element that provides a nonlinear response to electrical signals. Such elements include, but are not limited to, diodes, bipolar junction transistors, metal-oxide semiconductor field effect transistors (“MOSFET”) etc.

In illustrative embodiments of the invention, a microchip in a voice communication device, such as a cellular telephone, receives and processes voice signals from a microphone. The microchip is configured to internally attenuate RF carrier noise signals that may be induced in circuit elements of the microchip. Such noise signals are generated by transceiver circuitry that transmits and receives voice signals using a modulated RF carrier signal. A filter is provided at microchip ports through which such noise can enter the microchip. The filter attenuates RF carrier noise while allowing audio signals to pass substantially unaffected. Thus, modulated RF carrier noise signals are substantially suppressed before these signals interact with non-linear circuit elements in the microchip. Therefore, these non-linear circuit elements are less likely to convert these modulated noise signals into audio interference signals that disrupt audio signals from the microphone.

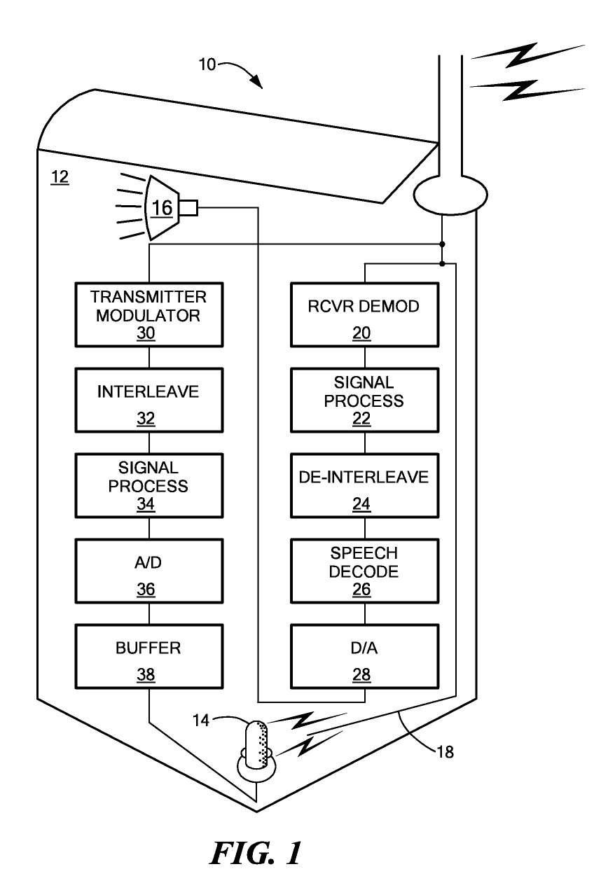

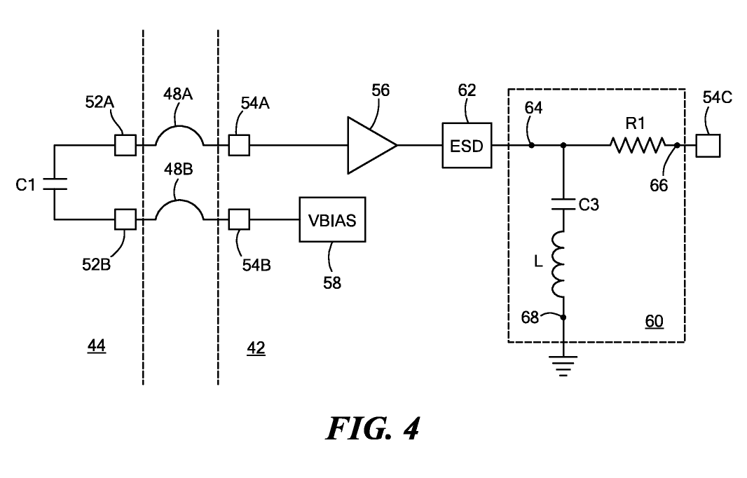

A cellular telephone similar to the cellular telephone 10 shown schematically in FIG. 1 may be used to implement illustrative embodiments of the invention. The microphone 14 acts as a transducer that converts sound into electronic signals. In illustrative embodiments, the microphone is a micro-electromechanical system (“MEMS”) microphone having a capacitance that varies as a function of incident sound waves. This capacitance is often referred to as the “capacitance of the microphone” and identified in FIG. 4 (discussed below) by reference indicator “C1.”

Associated microphone circuitry processes microphone signals from the microphone 14 for transmission through the antenna 18. For example, among other things, the microphone circuitry may amplify the microphone signal, provide a bias voltage to the microphone, and/or suppress potentially destructive electrostatic discharges. This circuitry may implement one or more sound signal processing functions such as, buffering 38, analog-to-digital conversion 36, signal processing 34, interleaving 32, and modulating 30, as shown in the block diagram of FIG. 1. In some embodiments, the microphone and microphone processing circuitry are integrated on a single chip. In other embodiments, however, the microphone and microphone processing circuitry are implemented on separate chips that are both contained within a single package. In illustrative embodiments, the microphone microchip circuitry may be implemented as an application specific integrated circuit (“ASIC”).

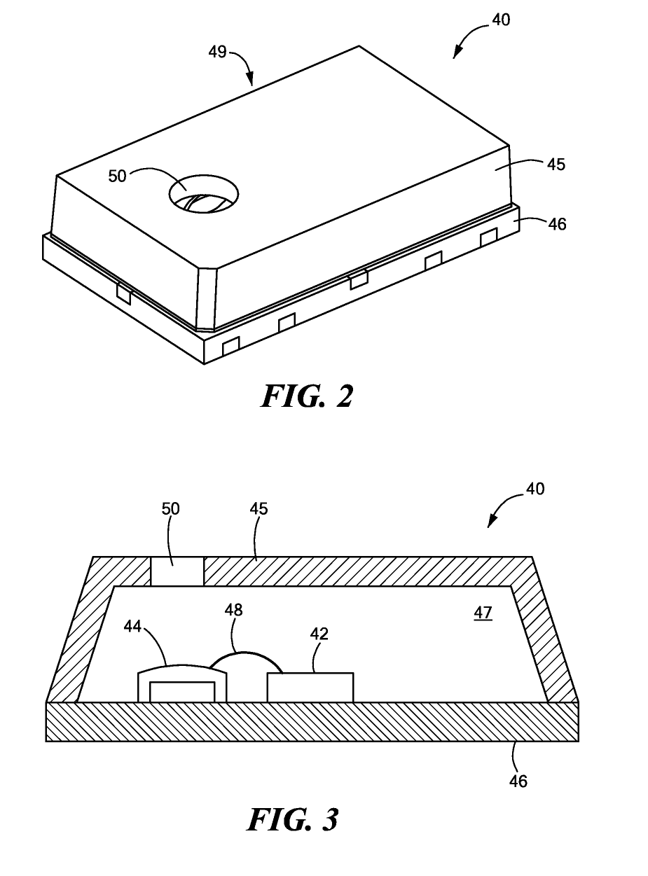

FIG. 2 schematically shows such a microphone system 40 implemented within a single package, while FIG. 3 schematically shows a cross-sectional view of the same microphone system 40. Specifically, the microphone system 40 shown generally in FIG. 2 (and in cross-section in FIG. 3) has a package 49 with a base 46 that, together with a corresponding lid 45, forms an interior chamber containing a MEMS microphone 44 and a microphone microchip 42. The lid 45 in this embodiment is a cavity-type lid, which has four walls extending generally orthogonally from a top, interior face to form a cavity 47. The lid 45 secures to the top face of the substantially flat package base 46 to form the interior cavity 47. The lid 45 also has an audio input port 50 that allows sound to enter the cavity 47. In alternative embodiments, however, the audio input port 50 may be at another location, such as through the package base 46, or through one of the side walls of the lid 45.

Audio signals entering the interior cavity 47 interact with the MEMS microphone 44 to produce an electrical signal that, after being processed by the microphone microchip 42 and additional (exterior) components (e.g., a transceiver), is transmitted via the antenna 18 to a receiving device (e.g., a cell tower). Although not shown, the bottom face of the package base 46 has a number of contacts for electrically (and physically, in many anticipated uses) connecting the microphone with a substrate, such as a printed circuit board or other electrical interconnect apparatus. In illustrative embodiments, the package base 46 is a premolded, lead frame-type package (also referred to as a “premolded package”). Other types of packages may be used, however, such as ceramic packages. Wire bonds 48 may connect the MEMS microphone 44 outputs with microphone microchip 42 inputs.

FIG. 4 is a circuit diagram of the MEMS microphone 44 and microphone microchip 42, shown in FIGS. 2 and 3, in an embodiment of the invention. The circuit has a variable capacitor C1 representing the variable capacitance, C1, of the MEMS microphone 44, and two bond pads 52A, 52B on the MEMS microphone 44 for connecting with corresponding bond pads 54A and 54B on the microphone microchip 42. The connections are made via wire bonds 48A, 48B. In other embodiments of the invention, where, for example, the microphone and microphone microchip circuits are implemented on a single chip, other forms of interconnection, as are known in the art, may be employed.

The microphone microchip 42 has an input pad 54A for receiving a microphone signal from the MEMS microphone 44. The input pad 54A connects to an amplifier/output buffer 56 that both buffers and level shifts the microphone signal. (For example, the amplifier 56 may shift the signal from the microphone anywhere from 0.6 volts to 1.2 volts DC.) The microphone microchip 42 also has a voltage bias generator 58 for providing a bias voltage for the variable capacitor C1 of the MEMS microphone 44. For example, this bias voltage may be about 4 volts. The voltage bias generator 58 communicates the bias voltage to the MEMS microphone 44 through a voltage bias output pad 54B to a voltage bias input pad 52B on the microphone 44. The amplifier/output buffer 56 in the microphone microchip 42 may be a programmable amplifier/output buffer. Further, electrostatic discharge suppression circuitry (referred to as “ESD”) for suppressing electrostatic discharges may be employed. ESD circuitry 62 typically includes a diode and may include other non-linear circuit elements.

The microphone signal is output from the microphone microchip 42 via bond pad 54C. Filter circuitry 60 may be provided as shown in FIG. 4 and as described below. The description of functions performed by the microphone microchip is exemplary and additional functions may be performed by additional circuitry on the chip, in various embodiments of the invention.

As noted above, the transmission/reception of RF signals by antenna 18 of the cellular telephone 10, as shown in FIG. 1, may induce a modulated RF carrier noise signal on the output bond pad 54C of the microphone microchip 42. For example, this RF interference signal may have a frequency of about 1 GHz if the cellular telephone 10 has an RF carrier frequency of 1 GHz. Non-linear circuit elements in the microphone microchip, such as the amplifier/output buffer 56 and ESD suppression circuitry 62 can convert the modulated RF carrier noise signal into interference at audio frequencies that can impact faithful transmission of the microphone signal. For example, bumblebee noise from time-interleaved transmissions in the RF carrier signal, as described above, can couple into the microphone signal path on the microphone microchip, impacting microphone signal fidelity.

In accordance with illustrative embodiments of the invention, the microphone microchip 42 includes an internal filter 60 that can substantially attenuate the induced RF carrier noise signals while allowing audio signals from the MEMS microphone 44 to pass substantially undisturbed. To that end, the microphone microchip 42 has a filter 60 configured to substantially attenuate interference signals at or near the frequency of the carrier signal that are coupled into the microchip. As shown in FIG. 4, the filter is connected between a potential point of entry of the RF carrier noise signals, such as output bond pad 54C, and nonlinear circuit elements such as the ESD suppression circuitry 62 and the output amplifier 56.

For example, this filter 60 may be a notch filter having its notch frequency (i.e., its frequency of greatest attenuation) at about 1.4 GHz. If the filter 60 is configured to have a notch at this frequency, then this filter should significantly attenuate the RF carrier noise signal in the range from about 1 GHz to 2 GHz, which may be induced on the microphone microchip 42.

One method of implementing this filter 60, as shown in FIG. 4, is with a capacitor C3 in series with an inductor L. The inductor L preferably is formed from very low resistance wire. The microphone microchip 42 also may have a resistor R1 to further improve performance. These components, as shown in FIG. 4, are electrically positioned between the signal output bond pad 54C and the ESD suppression circuitry 62. By connecting the filter 60 in this manner (64, 66, 68), the RF carrier noise signal can be significantly attenuated before the RF carrier noise signal can interact with non-linear elements in the microphone microchip 42, such as the diode in the ESD circuitry 62 and the amplifier/output buffer 56. Thus, the modulated RF carrier noise signal is much less likely to be converted to audio frequency interference at levels that adversely impact the microphone signal. Alternative embodiments of the filter omit the resistor R1, the inductor L, or both. Use of the inductor L provides the notch in the notch filter, however, and thus, its inclusion can improve performance.

As known by those skilled in the art, audio signals processed by the microphone microchip 42 have much lower frequencies than GigaHertz RF carrier signals. For example, audio signals may have frequencies on the order of tens of Hertz to several thousand Hertz. The filter 60 components, therefore, are selected to negligibly attenuate such low frequencies, while substantially attenuating signals at RF carrier frequencies. While a notch filter has been shown in FIG. 4, embodiments of the invention are by no means limited to such filters. Any filter circuit may be used, as is known in the art, that substantially attenuates RF frequency signals while passing signals at audio frequencies substantially unattenuated.

In other embodiments of the invention, filter circuitry may be used on other entry points for RF noise into the microphone microchip 42. For example, a filter may be inserted between microphone microchip power supply pads and the microchip circuitry. The filter is implemented so that RF carrier frequencies are substantially attenuated. Since the filter, in this case, is not in the signal path for the microphone signal, a simple low pass filter may be used, for example. Any filter circuit may be used, as is known in the art, that substantially attenuates RF frequency signals while passing, substantially unattenuated, signals at audio frequencies.

Although the above description discloses various exemplary embodiments of the invention, it should be apparent that those skilled in the art can make various modifications that will achieve some of the advantages of the invention without departing from the true scope of the invention.

What is claimed is:

1. A microchip for processing a microphone signal in a voice communication device, the device employing an RF carrier signal, the microchip comprising:
a port for receiving RF carrier signal noise;
a non-linear circuit element including a port to receive the microphone signal; and
an RF filter configured to substantially attenuate the RF carrier signal noise while passing the microphone signal substantially unattenuated,
wherein the RF filter is electrically connected between the RF carrier signal noise port and the non-linear circuit element.

2. A microchip according to claim 1, wherein the non-linear circuit element is a diode.

3. A microchip according to claim 1, wherein the non-linear circuit element is a bipolar junction transistor.

4. A microchip according to claim 1, wherein the non-linear circuit element is a metal oxide semiconductor field effect transistor.

5. A microchip according to claim 1, wherein the RF filter is a notch filter.

6. A microchip according to claim 1, wherein the RF filter includes a series resistance, the series resistance having a first end connected to the RF carrier noise port and a second end connected to the non-linear circuit element, the RF filter further including a series combination of a capacitance and an inductance, one end of the series combination of the capacitance and the inductance connected to a ground and the other end of the series combination of the capacitance and the inductance connected to the second end of the series resistance.

7. A microchip according to claim 1, wherein the RF filter includes a capacitance in series with an inductance.

8. A microchip according to claim 1, wherein the RF filter comprises a capacitor directly coupled to ground.

9. A microchip according to claim 1, wherein the RF carrier is in the range from about 1 GHz to about 2 GHz.

10. A microchip according to claim 1, wherein the non-linear element comprises an electrostatic suppression element.

11. A microchip according to claim 10, wherein the electrostatic suppression element includes a diode.

12. A microchip according to claim 10, wherein the electrostatic suppression element includes a bipolar junction transistor.

13. A microchip for processing a microphone signal in a voice communication device, the device employing an RF carrier signal, the microchip comprising:
a port for receiving RF carrier signal noise;
a non-linear circuit element including a port to receive the microphone signal; and
a filter means for substantially attenuating the RF carrier signal noise while passing the microphone signal substantially unattenuated,
wherein the filter means is electrically connected between the RF carrier signal noise port and the non-linear circuit element.

14. A microchip according to claim 13, wherein the non-linear element comprises an electrostatic suppression element.

15. A microchip according to claim 14, wherein the electrostatic suppression element includes a diode.

16. A microchip according to claim 14, wherein the electrostatic suppression element includes a bipolar junction transistor.

17. A microchip for processing a microphone signal in a voice communication device, the device employing an RF carrier signal, the microchip comprising:
a port for receiving RF carrier signal noise;
a non-linear circuit element; and
an RF filter configured to substantially attenuate the RF carrier signal noise,
wherein the RF filter is electrically connected between the RF carrier signal noise port and the non-linear circuit element.

18. A microchip according to claim 17, where the RF carrier signal noise port provides a voltage supply to the microchip.
